(19) United States
(12) Patent Application Publication
(10) Pub. No.: US 2007/0256536 A1
(43) Pub. Date: Nov. 8, 2007

(54) Adjustable hand rest post for musical instruments

(76) Inventors: Terry Barnard Ewell, Cockeysville, MD (US); Richard Glenn Spencer, Baltimore, MD (US)

Correspondence Address: Curtis E. Sherrer, 1301 Woods Hole Road, Towson, MD, 21286, US

(21) Appl. No.: 11/417,971

(22) Filed: May 4, 2006

(51) Int. Cl. G10D 7/10

(52) U.S. Cl. 84/387 A

(57) ABSTRACT

Adjustable hand rest post for a musical instrument, wherein the hand rest post is constructed to provide multiple adjustments of the position of the hand rest on which the hand or hands of the musical performer rest when playing a musical instrument, such as a bassoon or contrabassoon. The adjustable hand rest post incorporates an articulated hand rest post to allow for varying angles of adjustment. The adjustable positioning of the hand rest, achievable through adjustment of the articulated and adjustable hand rest post, reduces discomfort for the player and reduces injury with overuse. A bassoon is equipped with a key mechanism that is constructed using a tube that consists of a tenor joint, a boot (also known as a double) joint, a long joint, and a bell joint. A bassoon weighs approximately 8 pounds and is over 4 feet in length so that support of the instrument by the hands while playing without undue discomfort or fatigue is a significant concern. A contrabassoon is equipped with a key mechanism and is constructed using a tube of approximately double the length of the bassoon.

### BACKGROUND OF THE INVENTION

1. Field of Invention

The invention particularly relates to attaching an adjustable hand rest post to a musical instrument, such as a bassoon or contrabassoon, for positioning of the hand rest on which the left or right hand rest while performing on the instrument.

2. Prior Art

A bassoon (i.e., Fagott in German or fagotto in Italian) is a kind of woodwind instrument. The bassoon provides a key mechanism which operates to open or close sound holes which are arranged along a tube. A drawing of the front and back of a conventional bassoon is supplied in FIG. 1. (Also a drawing of a conventional bassoon is contained FIG. 3 in U.S. Pat. No. 5,892,167, of Apr. 6, 1999.)

A contrabassoon (i.e. Contrafagoft in German) is a kind of woodwind instrument. The contrabassoon provides a key mechanism which operates to open or close sound holes that are arranged along a tube. A drawing of the front and back of a conventional contrabassoon is supplied in FIG. 2.

FIG. 3 shows the parts of a conventional hand rest and post. A hand rest (i.e., crutch) is a formed piece of wood, plastic, or synthetic polymers, affixed to a metal rod. A hand rest post 5A is a metal unit into which the hand rest rod 2 is placed and is then fixed into position with a thumb screw 3. The conventional hand rest and post together consist of: the hand rest 1, hand rest rod 2, thumb screw 3, a hand rest post 5A, a curved plate 12, and screw holes in the curved plate 11. Occasionally, a hand rest post includes a boss 4.

The hand rest post is attached to the bassoon on the boot (also known as the double) joint, that is, the lowermost joint, with four wood screws in the position shown in FIG. 4. This hand rest post is positioned for the player's right hand, between the E key and the A hole (finger 5 on FIG. 1).

The conventional example of the bassoon hand rest post has the problem that the hand rest, while exhibiting rotational mobility about the post axis, cannot be adjusted along the long (top-to-bottom) or short (side-to-side; lateral) dimensions of the bassoon. The conventional hand rest post is fixed in a position at an angle of 90 degrees from the body of the bassoon, thus requiring the right hand wrist of bassoon players to be flexed at an angle of nearly 90 degrees in order to use the conventional hand rest post. This positioning of the wrist causes discomfort and fatigue of the hand, and can result in injury with overuse. Further, the lack of adjustability of the conventional hand rest post limits the ability to balance the instrument in the playing position, leading to difficulties in maintaining the position of the instrument for long periods of time while playing. Further, the conventional example of the bassoon hand rest post has the problem that, due to its lack of adjustability, its position cannot be adapted for use with the left hand in the position shown in FIG. 9.

An adjustable hand rest apparatus, manufactured by Musik Spiri of Switzerland, is made of record. There are several disadvantages associated with this hand rest.

1. The Musik Spiri hand rest apparatus does not allow for the use of the player's existing hand rest, i.e., crutch. Experienced and professional players in particular become accustomed to the use of their own particular hand rest for optimal performance, so this is a significant limitation of the Musik Spiri device. In contrast, with the disclosed adjustable hand rest post, a player can use the hand rest to which he or she has become accustomed and practiced. This is because the adjustable portion of the disclosed device is a hand rest post, into which a conventional hand rest, such as the performer's preferred hand rest, is inserted in the conventional fashion.

2. The Musik Spiri apparatus, due to its design, has a limited range of lateral angle through which it can be adjusted. This substantially limits the ability of the performer to obtain an optimally comfortable playing position, and requires a greater amount of hand flexion for its use than is generally desirable. In contrast, the disclosed inventive adjustable hand rest post has a much greater range of lateral angle through with it can be adjusted and fixed than does the Musik Spiri apparatus. This permits the player to perform with whatever amount of hand flexion is desired, without any limitations.

3. The Musik Spiri apparatus is more complex in its manufacture, requiring more bearings, more adjustment screws, and a substantial modification of the hand rest (i.e. crutch) itself. The latter must be partially hollowed out in order to attach the Musik Spiri apparatus. In contrast, the instant adjustable hand rest post is simpler to manufacture, requiring only a single hinge joint in the preferred embodiment.

4. The complexity of the Musik Spiri device, and the fact that it consists of not only a modified hand rest post but also of a modified hand rest, leads to substantial cost. In contrast, the instant adjustable hand rest post is much simpler in design and manufacture, and permits use of the player's pre-existing hand rest, and is hence substantially less costly.

5. The adjustment of the Musik Spiri apparatus is complicated by its use of multiple attachment screws which must be loosened for adjustment, and then tightened for performance. In contrast, the instant hand rest post can be easily and quickly adjusted by a single screw. This adjustment is sufficiently rapid that it can be readily carried out during rest periods during a performance.

6. The Musik Spiri apparatus does not permit adjustment in height of the hand rest, because it is based on sliding ball-and-socket joints. Therefore, once the Musik Spiri device is constructed and installed onto the bassoon, there is no capacity to adjust the position of the player's hand closer or farther from the instrument. This is a significant limitation, as even the conventional hand rest apparatus permits such adjustment, which is regarded as crucial. In contrast to the Musik Spiri device, the instant hand rest post permits adjustment of the position of the player's hand closer or farther from the instrument, to the same degree as in the case of the conventional hand rest apparatus.

### SUMMARY OF THE INVENTION

It is the object of the invention to provide multiple adjustments of the hand rest post into which a hand rest is inserted for the bassoon and contrabassoon. Below are samples of particular applications, but these applications do not limit the development of different solutions to adjustments in the hand rest post. The purpose of this invention is to improve comfort and lessen fatigue and strain of the hands and forearms of the bassoon performer. This is achieved by allowing the bassoon player to adjust the angle of the hand rest post to any angle with respect to the body of the bassoon, typically substantially less than the 90 degrees required by the conventional hand rest apparatus. This lesser and adjustable amount of flexion of the wrist and hand leads to less hand and forearm fatigue while playing the instrument for extended periods of time, thereby increasing performance facility and quality.

An additional object of the invention is to allow for better balance of the bassoon or contrabassoon, whether the performer is seated or standing, through optimal positioning of the hands, thereby modifying and reducing the forces exerted on the instrument to maintain it in the playing position, again reducing fatigue and strain on the performer's hands and arms.

### BRIEF DESCRIPTION OF THE DRAWINGS

These and other objects of the subject invention will become more fully apparent as the following description is read in light of the attached drawings wherein:

FIG. 1 is a back and front view of the bassoon as conventionally known.

FIG. 2 is a back and front view of the contrabassoon as conventionally known.

FIG. 3 is a plan view of a bassoon hand rest and post assembly as conventionally known.

FIG. 4 is a back view of the boot joint of a bassoon with the bassoon hand rest and post assembly as conventionally known.

FIG. 5 is a plan view showing the invention with its component parts.

FIG. 6 is a plan view of the curved base plate and its component as viewed from above.

FIG. 7 is a plan view of the invention shown at an angle.

FIG. 7A is a plan view of the invention showing the angle of rotation θ, (theta).

FIG. 8 is a plan view of the invention shown at an angle with placement of the thumbscrew.

FIG. 9 is a plan view of the invention placed on the long joint of a bassoon for use of the player's left hand.

FIG. 10 is a plan view of the invention modified with a single ball-and-socket joint with variable angle upper post.

FIG. 11 is a plan view of the invention modified with a double ball-and-socket joint.

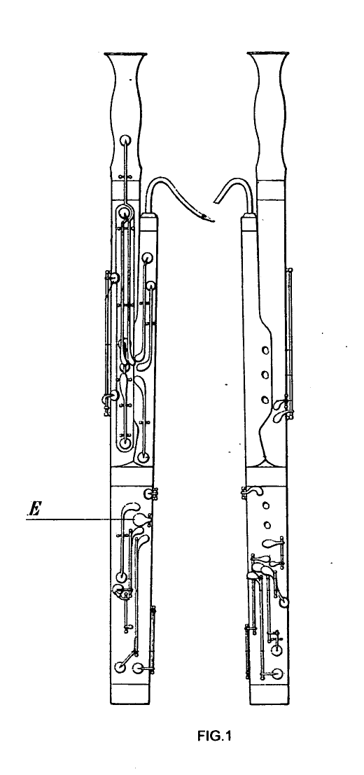

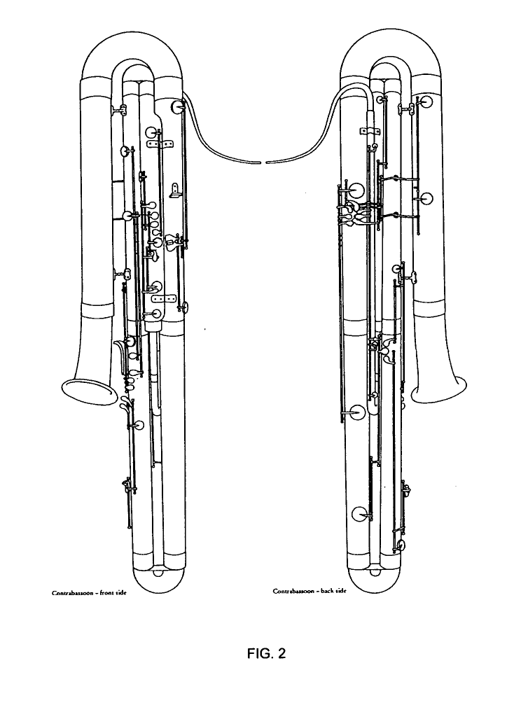

### DESCRIPTION OF THE PREFERRED EMBODIMENT

Variable Angle Hand Rest Post

When the desired angle of inclination is found in the variable angle hand rest post the hinging mechanism is locked into position by tightening the socket head cap screw. Alternatively a thumb screw or other screw may be utilized instead of the socket head cap screw.

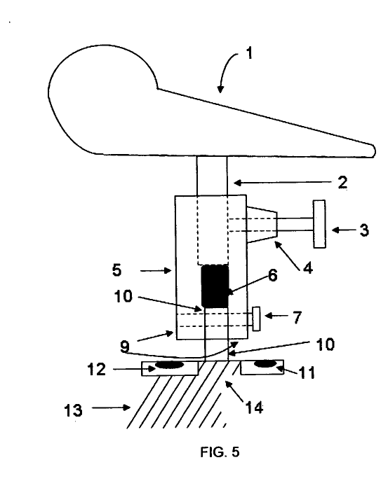

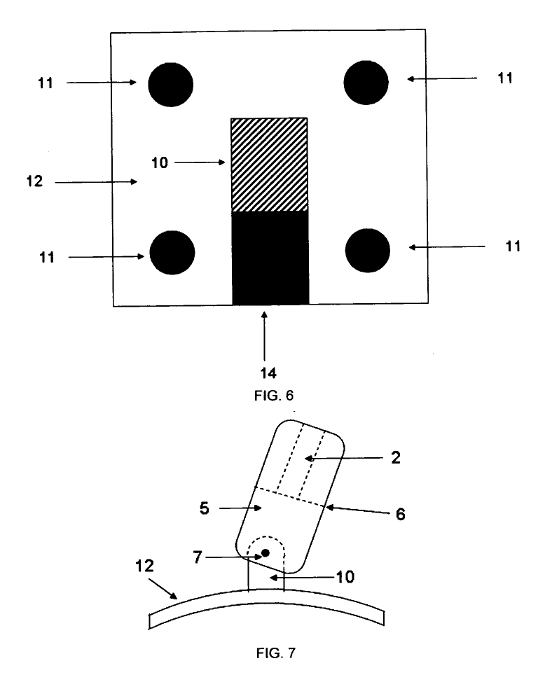

FIG. 5 details the present embodiment of the invention. As in the conventional hand rest post design, a base plate 12 (curved to a radius to conform to the body of the instrument) with screw holes 11 is attached by means of wood screws between the low E sound hole (covered by the E key) and the A sound hole of the boot joint, otherwise known as the double (lowermost) joint, of the instrument. (See FIG. 6 for another view of the base plate 12.)

The screws, bolts, etc. used for fastening the base plate to the body of the instrument may be modified by extending their depth or increasing their width in order to further stabilize the hand rest beyond what is required for the conventional static hand rest. The plate 12 may also be affixed to the instrument with an adhesive or bonding agent, screws, nails, clamps or by other means that are well known in the fastening art. The anchor post 10 is attached to the curved plate 12. The adjustable post unit 5 has a slot sufficiently wide to fit the anchor post 10; the anchor post 10 and adjustable post unit 5 are fastened together, for example, by means of a screw 7 through a hole in each.

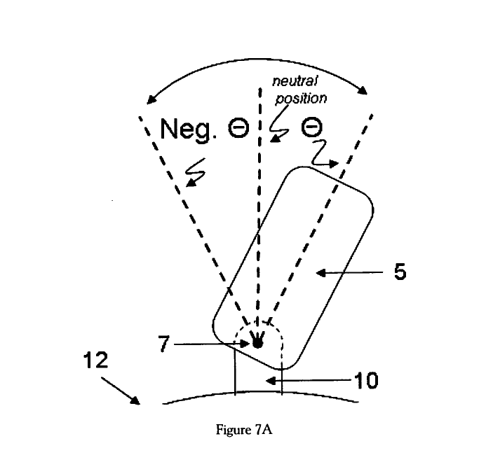

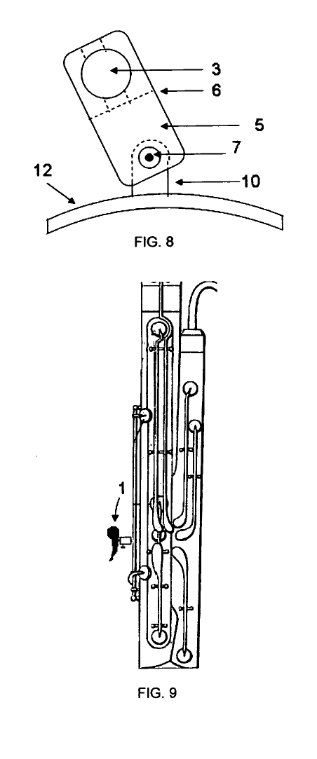

The adjustable post 5 has threads on the thicker foot 9 at its base (at the side furthest from the head of the screw) for the socket head cap screw to be fastened into. The anchor post feet 9 have a rounded contour that allows for free lateral movement of the adjustable post unit (See FIGS. 7, 7A and 8). The adjustable post unit 5 is further split 6 above the joint with the anchor post to allow for the feet of the adjustable post to flex with the tightening of the bolt 7 so that the joint is secured when the desired angle is found.

The adjustable post unit 5 has two other holes in it, conforming to the conventional bassoon hand rest post. One threaded hole is directed inward from the side of the adjustable post unit on the side of the adjustable post unit (through the illustrated boss 4) and is for the entrance of a thumbscrew 3 to hold and tighten the rod 2 of the hand rest 1.

The second hole is not threaded and is oriented vertically outward along the long axis of the adjustable post unit. This hole is for the entrance of the pin 2 of the hand rest. It is this axis about which the conventional hand rest, as well as the variable angle bassoon hand rest post, has rotational mobility.

FIG. 6 gives a top down view of the curved base plate 12 with the anchor post 10 and the four screw holes 11. Additional screw holes may be added to stabilize the base plate 12 or the plate may be fixed to the bassoon with an adhesive or bonding agent. The base plate 12 may be modified to fit the standard hole placement of different makes of instruments, such as bassoons or contrabassoons. Please notice that segment 14 of the plate is cut out in order to allow for the free motion of the key work for the E key, that is, the key that covers the low E hole on the boot joint of the bassoon.

FIGS. 7, 7A and 8 show the adjustable post 5 tilting at an angle to the bassoon body. Adjustments can achieve an angle ranging from 0 degrees to about 90 degrees in either direction (+ or −), which can be designated as −90 to +90 degrees from the vertical axis that is perpendicular to the base plate 12. This lateral angular range is limited only by hindrance from the existing keywork of the instrument at the extreme angles, and not by the variable angle hand rest post device itself. For example, the angle of rotation can range from +95 to −95, +100 to −100 degrees, etc.

### Other Embodiments of the Invention

Single Ball-and-Socket Joint with Variable Angle Upper Post

This modification of the invention utilizes a single ball-and-socket joint with a variable angle upper joint to permit adjustment of the hand rest along both the long (top-to-bottom) and short (side-to-side; lateral) dimensions of the bassoon as well as rotation of the entire mechanism.

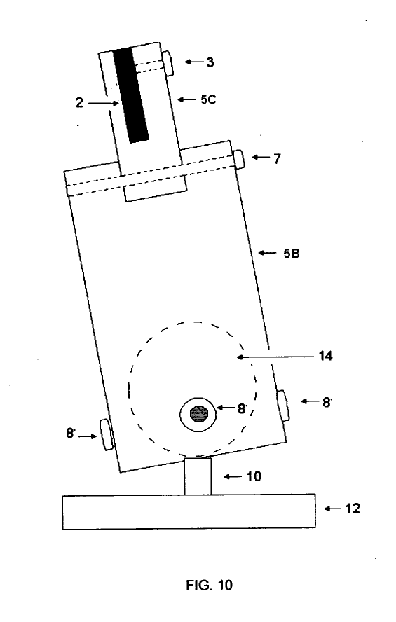

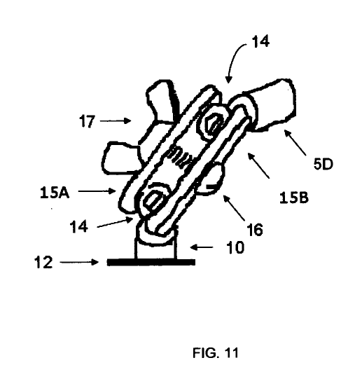

FIG. 10 details the hand rest and posts with the modifications. The curved base plate 12 attaches to the body of the instrument by means of wood screws or adhesive or by other means. The ball 14 and socket design at the bottom of the fixed and moveable posts allow for mobility at many angles and rotations. The ball 14 attached to the fixed post is locked into position in the socket of the moveable post 5B by means of four socket head cap screws 8. The base of the moveable post 5B is hollowed out to allow for free motion of the ball 14. Other means of securing the ball and socket may be used as well. An alternative design could have the fixed post with the socket and the moveable post with the ball.

The moveable post 5B has a slot sufficiently wide to fit the variable angle upper post. This upper post and the moveable post unit are fastened together by means of a socket head cap screw 7 through a hole in each. The adjustable post has threads on the side furthest from the head of the screw for the socket head cap screw to be fastened into. Alternatively a thumbscrew or other screw may be utilized instead of the socket head cap screw. The upper post has a rounded contour that allows for free lateral movement within the moveable post unit (similar to FIG. 5).

The moveable post unit 5B may be further split below the joint to allow for the unit to flex with the tightening of the hex bolt so the joint is secured when the desired angle is found. The upper post unit 5C has two other holes in it conforming to the conventional bassoon hand rest post. One threaded hole is directed inward from the side of the adjustable post unit on the side of the adjustable post unit and is for the entrance of a thumbscrew to hold and tighten the pin of the hand rest. The second hole is not threaded and is oriented vertically outward along the long axis of the upper post unit. This hole is for the entrance of the pin of the hand rest. It is this axis about which the conventional hand rest, as well as the instant variable angle hand rest post, has rotational mobility.

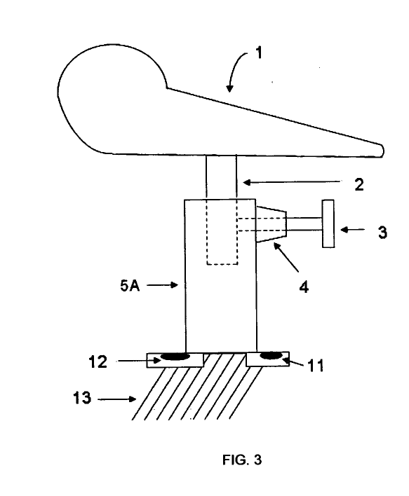

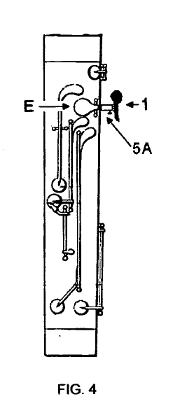

A single ball-and-socket joint can be utilized as an alternative to this design that is without the variable angle upper post pivoting about the screw 8. It would contain the conventional upper two holes for the hand rest (the upper part of FIG. 3)

Double Ball-and-Socket Hand Rest Post

The modification of this invention utilizes two ball-and-socket joints which permit the adjustment of the hand rest along both the long (top-to-bottom) and short (side-to-side; lateral) dimensions of the instrument as well as rotation of the entire mechanism. See FIG. 11. Illustrated is a conventional double-ball-and-socket joint which permits full three-dimensional mobility of the adjustable post unit about the anchor post. The hand rest post is comprised of two plates 15A and 15B, which house upper and lower balls 14 and is held together, for example, by a bolt and wing nut. The hand rest rod is inserted into 5D which is attached to the upper ball 14. The lower ball 14 is attached to the anchor post 10, which is then fixed to the base plate 12. Adjustment is performed by loosening the illustrated wing nut 17, which is wound on to the screw 16. Once the desired position of the hand rest is obtained the wing nut 17 is tightened. This is one example of a ball-and-socket joint permitting such mobility. The wing nut can be replaced by a thumbscrew or other fastening device. Aside from the ball-and-socket mechanism, the upper portion of the variable angle hand rest is as described above.

Fully Adjustable Flexible Steel or Other Tubing Hand Rest Post

This invention (not shown) permits adjustment of the hand rest along both the long (top-to-bottom) or short (side-to-side; lateral) dimensions of the instrument. A conventional flexible steel tubing joint, affixed to the curved base plate on one end, and affixed to a hand rest post on the other end permits full three-dimensional mobility of the hand rest. Other types of flexible tubing material may be utilized as well. The hand rest may also be affixed permanently to the flexible tube, since the rotational degree of freedom imparted by the conventional pin of the hand rest is adequately represented by the range of motion of the flexible tube.

As these inventions may be embodied in several forms without departing from the spirit of the essential characteristics thereof, the present embodiment is therefore illustrative and not restrictive, since the scope of the invention is defined by the appended claims rather than by the description preceding them, and all changes that fall within metes and bounds of the claims, or equivalents of such metes and bounds, are therefore intended to be embraced by the claims.

What is claimed is:

1. A variable angle hand rest post for a musical instrument comprising:
an adjustable post unit with two ends,
the two ends include a first upper, end having a hole for affixing a hand rest peg;
and a second lower, end for affixing an anchor post;
the anchor post is affixed to a curved plate;
said adjustable post can be realigned, adjusted, or angled differently when desired, but then secured to remain in a fixed position for musical practice or performance,
wherein the musical instrument is a bassoon or a contrabassoon.

2. The attachment of claim 1, wherein said attachment can be used for the left or right hand.

3. The attachment of claim 1, wherein the hole for the hand rest peg measures up to ½ inch diameter.

4. The attachment of claim 1, wherein said anchor post, curved plate, and adjustable post unit are constructed from materials selected from the group consisting of wood, plastic, synthetic polymers, graphite, metal, or combinations thereof.

5. The attachment of claim 1, wherein the curved plate can be attached to the musical instrument by means selected from the group consisting of an adhesive, screws, nails, clamp, or a combination thereof.

6. The attachment of claim 1, wherein a slot is provided on the curved plate; said slot positioned so as to provide room for the E key on a bassoon.

7. The attachment of claim 1, wherein the hand rest peg is secured into the hole of the adjustable post by means selected from the group consisting of a thumbscrew, wing nut, or screw.

8. The attachment of claim 1, wherein the adjustable post having a length and a slot extending from its second end to about halfway up its length, said slot capable of receiving said anchor post.

9. The attachment of claim 1, wherein the anchor post is attached to the adjustable post so that the adjustable post can rotate in a plane to an angle from to at least 90 degrees from the perpendicular in either direction.

10. A variable angle hand rest for a musical instrument comprising:
a hand rest that includes a peg,
an adjustable post unit with two ends,
the two ends include a first upper end for affixing the hand rest peg
and a second lower end for affixing an anchor post;
the anchor post is affixed to a curved plate,
said adjustable post can be realigned, adjusted, or angled differently when desired, but then secured to remain in a fixed position for musical practice or performance,
wherein the musical instrument is a bassoon or a contrabassoon.

11. The attachment of claim 10, wherein said attachment can be used for the left or right hand.

12. The attachment of claim 10, wherein the hole for the hand rest peg measures up to ½ inch diameter.

13. The attachment of claim 10, wherein said anchor post, curved plate, and adjustable post unit are constructed from materials selected from the group consisting of wood, plastic, synthetic polymers, graphite, metal, or combinations thereof.

14. The attachment of claim 10, wherein the curved plate is attached to the musical instrument by means selected from the group consisting of an adhesive, screws, nails, clamp, or a combination thereof.

15. The attachment of claim 10, wherein a slot is provided on the curved plate; said slot positioned so as to provide room for the E key on a bassoon.

16. The attachment of claim 10, wherein the hand rest peg is located in the hole of the adjustable post at its first upper end and secured by the means selected from the group consisting of a thumbscrew, wing nut, or screw.

17. The attachment of claim 10, wherein the adjustable post having a length and a slot extending from its second end to about halfway up its length, said slot capable of receiving said anchor post.

18. The attachment of claim 10, wherein the anchor post is attached to the adjustable post so that the adjustable post can rotate in a plane to an angle from 0 to at least 90 degrees from the perpendicular in either direction.

19. A method of using the variable angle hand rest post of claim 1 or claim 10 comprising the steps of:
inserting and securing a hand rest peg into the hole of the adjustable post at its first upper end,
adjusting the adjustable post relative to the anchor post at an angle,
and securing the adjustable post in a position relative to the anchor post, with the curved plate affixed to the body of the instrument.
